(19) United States
(12) Patent Application Publication
(10) Pub. No.: US 2022/0012206 A1
(43) Pub. Date: Jan. 13, 2022

(54) VERSATILE ADAPTOR FOR HIGH COMMUNICATION LINK PACKING DENSITY

(71) Applicant: Intel Corporation, Santa Clara, CA (US)

(72) Inventors: Kevin BROSS, Tigard, OR (US); Benjamin CHEONG, Tigard, OR (US); Danae A. BERGE, Hillsboro, OR (US); April E. FISHER, Hillsboro, OR (US)

(21) Appl. No.: 17/484,768

(22) Filed: Sep. 24, 2021

(51) Int. Cl. G06F 13/40; G06F 13/42

(52) U.S. Cl. CPC G06F 13/4072; G06F 2213/0016; G06F 13/4282

(57) ABSTRACT

An adaptor is described. The adaptor includes a first interface. The first interface is designed to support traffic and command flows to multiple transceivers through a single instance of the first interface. The adaptor includes multiple interfaces on a transceiver side. The multiple interfaces are to mate to respective transceivers. The multiple interfaces are different than the first interface, wherein the first interface is a QSFP interface and the multiple interfaces are SFP interfaces. The adaptor includes a flex cable between the first interface and the multiple interfaces. The adaptor includes electronic circuitry to translate QSFP commands received at the first interface into SFP commands presented to the respective transceivers through the multiple interfaces.

### BACKGROUND

System design engineers face challenges, especially with respect to high performance data center computing, as both computers and networks continue to pack higher and higher levels of performance into smaller and smaller packages. Creative packaging solutions are therefore being designed to keep pace with the thermal requirements of such aggressively designed systems.

### FIGURES

A better understanding of the present invention can be obtained from the following detailed description in conjunction with the following drawings, in which:

FIG. 1 shows a transceiver (prior art);

FIG. 2 shows an adaptor;

FIGS. 3a, 3b and 3c show different uses of the adaptor of FIG. 2;

FIG. 4 shows first electronic circuitry for the adaptor of FIG. 2;

FIG. 5 shows second electronic circuitry for the adaptor of FIG. 2;

FIG. 6 shows a system;

FIG. 7 shows a data center;

FIG. 8 shows a rack.

### DETAILED DESCRIPTION

A optical transceiver is a communication device that performs both optical-to-electrical and electrical-to-optical conversions for ingress and egress data flows, respectively. With an optical transceiver, a host electronic system (e.g., a computer, a networking switch) can send an electrical egress signal to the transceiver. The transceiver, in turn, converts the electrical egress signal to an optical egress signal and launches it into a fiber optic cable. Likewise, the optical transceiver can receive an optical ingress signal from a fiber optic cable, convert it to electrical form, and then present it to the host as an electrical ingress signal.

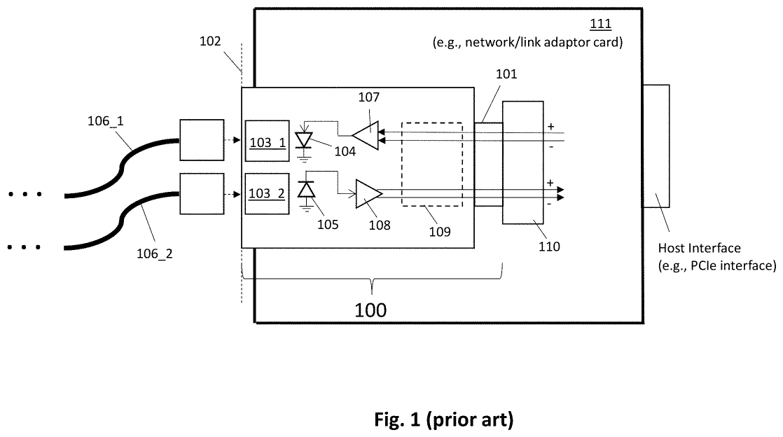

FIG. 1 depicts a single lane optical transceiver 100. As observed in FIG. 1, the optical transceiver 100 includes an electrical interface 101 on its host side and an optical interface 102 on its external ingress/egress side. The electrical interface 101 typically includes electrical I/Os (e.g., edge connectors, pins, pads, balls, etc.) while the optical interface 102 includes a pair of fiber optic cable receptacles 103_1, 103_2.

With respect to the optical interface 102, for a single channel, a first fiber optic cable receptacle 103_1 is coupled to an optical transmitter 104 (e.g., a laser or light emitting diode) that performs electrical to optical conversion for the egress signals. A second fiber optic cable receptacle 103_2 is coupled to an optical receiver 105 (e.g., a photo-diode) that performs optical to electrical conversion for ingress signals. A first optical cable plugs 106_1 into the first receptacle 103_1 to form the optical egress channel and a second optical cable 106_2 plugs into the second receptacle 103_2 to form the optical ingress channel.

With respect to electronic circuitry, a single lane optical transceiver typically includes a laser driver 107 and a transimpedance amplifier 108. Other supporting electronic circuitry 109 can exist (but need not exist) depending on any of the specific industry standard to which the transceiver conforms, the manufacturer, the model, etc. Such circuity 109 can be designed to perform, e.g., clock recovery and retiming, equalization, etc. (in either or both of the ingress and egress directions) among other possible functions.

Regardless, the transceiver's electrical interface 101 “plugs into” a connector 110 on an electronic circuit board 111. The electronic circuit board 101 is typically electrically/mechanically integrated with the host system (e.g., the electronic circuit board 101 can be the host system's motherboard, a network adaptor card that plugs into the host, etc.). The connector 110 mechanically and electrically integrates the transceiver 100 with the circuit board 111.

Traditionally, optical transceivers have mostly conformed to the gigabit interface converter (GBIC) industry standard (published by the Small Form Factor Committee) which has been used for both Gigabit Ethernet and Fibre Channel optical links. However, with the emergence of cloud computing, big data, 5G, etc., an increased demand for fiber optic links has emerged. In essence, the increased demand for real-time data is being met by integrating large numbers of fiber optic links into the communication infrastructure.

A number of smaller form factor optical transceivers have therefore recently emerged. Some of these include “small form-factor pluggable” (SFP), SFP+, SFP-DD, SFP28, SFP56 “dual small form factor pluggable” (DSFP), “quad small form-factor pluggable” (QSFP), QSFP28, QSFP56, QSFP+, etc. (whose specifications are provided by the the Small Form Factor Technology Affiliate Technical Working Group (SFF TA TWG) which is organized under the Storage Networking Industry Association (SNIA)). Additional variants (including variants that support copper wire links rather than optical fiber links), both current and emerging (e.g., XSP, “octal small form-factor” (OSFP)), exist and/or are expected to exist.

A problem, however, is that the myriad of different transceivers has resulted in electrical interfaces 101 that are incompatible with one another. Specifically, although SFP and its variants (e.g., SFP+, SFP28, SFP56, etc.) are compatible with one another and QSFP and its variants (e.g., QSFP+, QSFP28, QSFP56, etc.) are compatible with one another, the SFP interface (and its variants) is not compatible with QSFP interface (and its variants). In particular, a QSFP optical transceiver includes four lanes (whereas an SFP transceiver includes only a single lane) integrated into a form factor that is only slightly larger than an SFP transceiver (a single QSFP package includes four separate optical transceivers).

The incompatibility presents challenges to system administrators who purchase network adaptor cards and other circuit boards having one or more transceiver connectors 110 based on expectations concerning the types of optical links that will plug into them. Often, however, such expectations are not realized and/or circumstances change over time that render a card/board purchased with a particular type of connector useless.

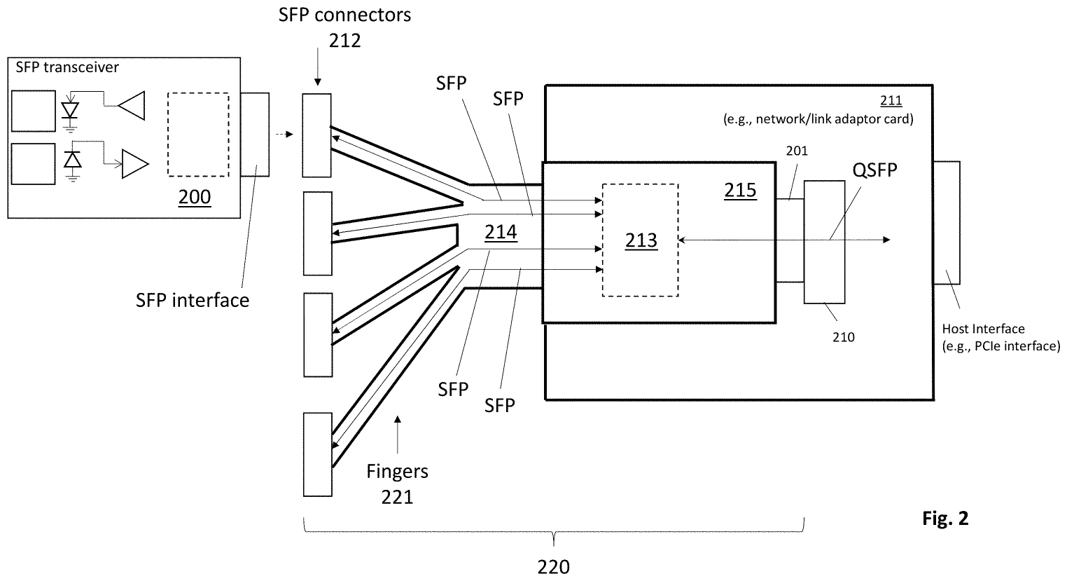

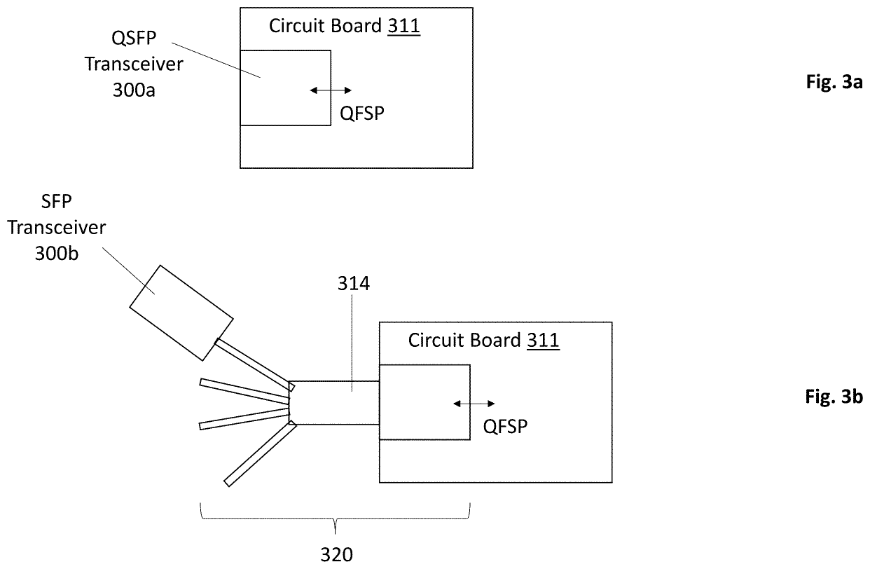

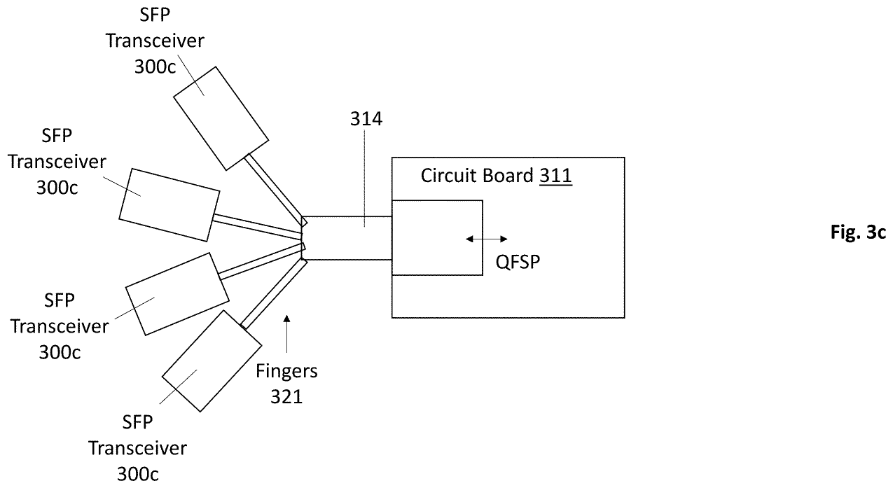

FIG. 2 and FIGS. 3a through 3c pertain to an improved approach in which a common circuit board connector 210 is maintained across multiple (e.g., all) circuit boards. In an embodiment, the common circuit board connector 210 is a QSFP based connector because it supports a larger number of lanes per transceiver/connector pair (four).

As depicted in FIG. 3a, if a QSFP transceiver 300a (or a QSFP variant) is to be used with the circuit board 311, the QSFP transceiver 300a plugs directly into the connector 310.

By contrast, as observed in FIGS. 2 and 3b, if a transceiver 200, 300b other than a QSFP form factor transceiver is to be used with the circuit board 211, 311, such as an SFP transceiver 300b (or any SFP variant), an intermediary adaptor 220, 320 is used to enable communication between the SFP transceiver 200, 300b and the host system through the circuit board's QSFP connector 210.

Here, the intermediary adaptor 220, 320 includes a QSFP interface 201 on its host side and four SFP connectors 212 on its transceiver side. The SFP connectors 212 are coupled to an adaptor module 215 by a flex cable 214, 314. When the adaptor module is connected to the circuit board connector 210 by way of QSFP interface 201, the presence of the flex cable 214, 314 causes the adaptor's SFP connectors 212 to hang down (“dangle”) from the adaptor module 215.

The SFP transceiver 200, 300b plugs into one of the SFP connectors 212. The adaptor 220, 320 thereafter enables signals to be passed from the circuit board 211, 311 to the SFP transceiver 200, 300b in the egress direction and from the SFP transceiver 200, 300b to the circuit board 310 in the ingress direction.

Notably, the specific configuration of FIG. 3b shows only a single SFP transceiver 300b that is coupled to the adaptor 320. However, as discussed above, a QSFP transceiver can support up to four fiber optic lanes. As such, the QSFP connector 210, 310 on the circuit board 211, 311 can support up to four lanes of traffic (four separate serial data channels).

As such, as observed in FIGS. 2 and 3c the adaptor includes four separate fingers 221, 321 on its transceiver side where each finger is terminated with an SFP connector 212. Here, the four separate data channels that flow through the circuit board's QSFP connector 210 are individually routed to a different finger and corresponding SFP connector (each finger supports one data channel). As such, in a maximum throughput mode, as observed in FIG. 3c, four separate SFP transceivers can be plugged into the adaptor (one SFP transceiver per finger). In other configurations two or three SFP transceivers can be coupled to the adaptor.

As observed in FIG. 2, the adaptor module package 215 includes circuitry 213 to assist in the communication between the host and the transceiver(s) 200.

In an embodiment, the circuitry 213 includes one or more of a micro-controller, state machine logic circuit and/or application specific integrated circuit (ASIC) implemented on one or more semiconductor chips that converts, e.g., QSFP protocol signals/commands sent from the circuit board's connector 210 to SFP signals/commands presented at the SFP connectors 212 at the ends of the fingers 221. In this case, the device driver and/or other, e.g., low level program code and/or hardware that is used by the host to communicate to the transceiver 200 (e.g., to configure or otherwise control the transceiver 200) sends and receives QSFP signals through the QSFP connector 210 (e.g., the host believes it is communicating with a QSFP transceiver).

In another embodiment, the circuitry 213 is largely re-driver circuitry that essentially forwards (rather than processes and re-interprets) the signals sent by the host through connector 210 to the transceiver(s) 200. In this case, the host recognizes what type of transceiver is physically sending/receiving optical signals to/from the system and sends commands that are specific to that type of transceiver (SFP) 200 through the circuit board connector 210 (e.g., SFP specific commands are sent through the QSFP connector 210).

In still further embodiments the circuitry 213 can include other functions depending on implementation (e.g., equalization, retiming and clock recovery in one or both of the transmit and receive directions, and/or forward error correction in the receive direction).

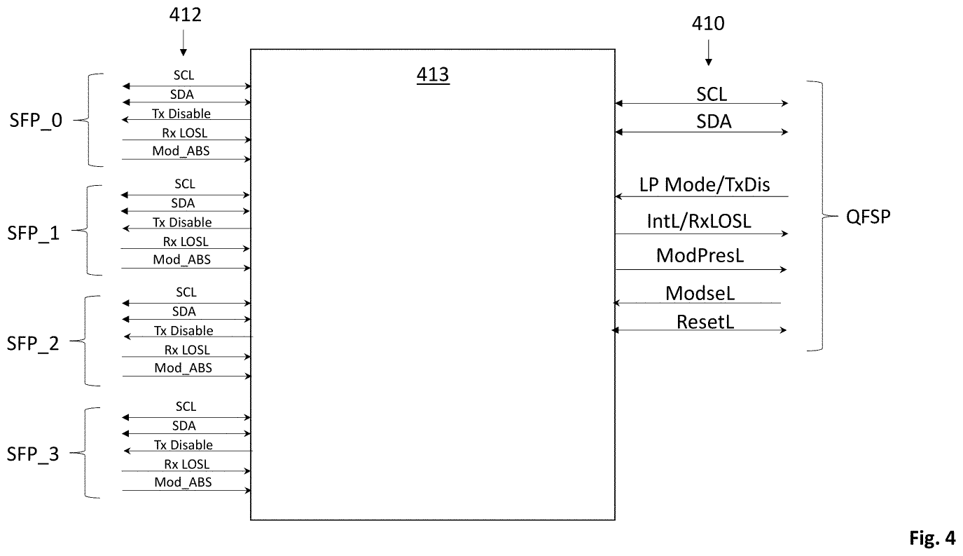

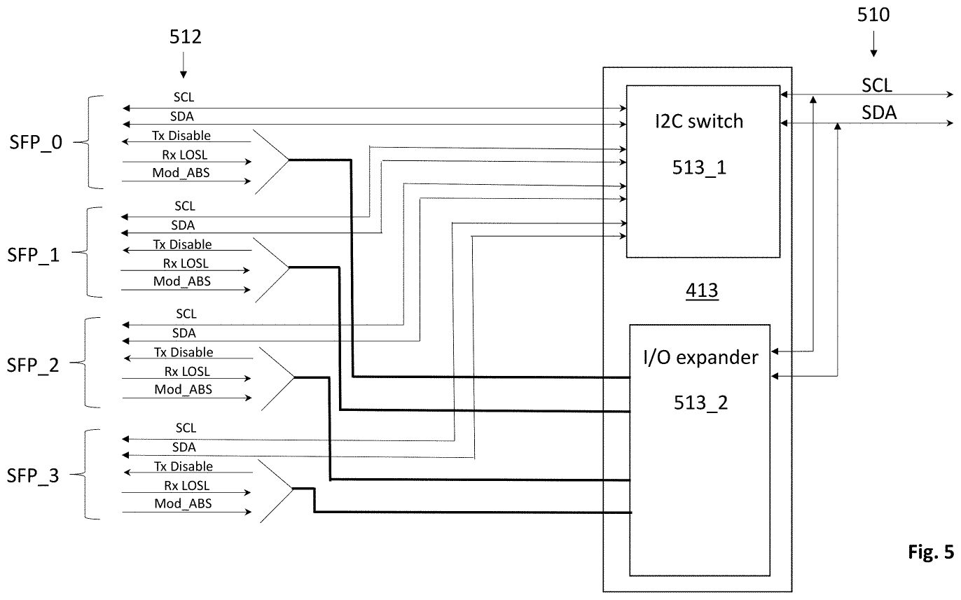

With respect to the first embodiment described just above, in which circuitry 213 converts QSFP protocol signals/commands sent from the circuit board's connector to SFP signals/commands that are presented at the transceiver's electrical interface, FIG. 4 shows a more detailed embodiment of the circuitry 413 for that particular approach. With respect to the second embodiment described above, in which SFP specific commands are sent through the QSFP connector 210, FIG. 5 shows a more detailed embodiment of the circuitry 513 for that particular approach.

It is pertinent to point out that FIGS. 4 and 5 and their corresponding discussion focus on the control signaling that exists between the host and an SFP transceiver. As such, the data signals that flow through both the SFP and QSFP interfaces are not described or discussed. However, the reader should understand that they exist within these interfaces and are transported over the flex cable between the transceivers and the host.

As observed in FIG. 4, both the QSFP 410 and SFP 412 interfaces include SCL and SDA lines for implementing an I²C control channel. I²C is primarily used to communicate configuration or other control commands from a host to a peripheral device that is targeted by the command(s). Both SFP and QSFP transceivers include I²C control capability. However, for QSFP devices, which of the four lanes is being targeted by a command is included in the SCL, SDA signaling over the I²C control channel.

As observed in FIG. 4, there are four SFP interface instances (one for each finger). In operation, translation circuitry 413 receives a command signal and information that identifies one of four transceivers on the SCL and/or SDA lines of the QSFP interface 410. The translation circuitry processes the information that identifies which transceiver is targeted and then routes the command on the SCL and/or SDA lines of the particular one of the SFP interfaces 412 that corresponds to that transceiver.

The QSFP interface 410 also includes an “LpMode/TxDis” input pin that is nominally used with QSFP transceivers to transport two signals from the host to all four transceivers in a QSFP package: 1) a low power mode; and, 2) an (optional) transmitter disabled mode (in the transmitter disabled mode, the optical transmitter of all four transceivers in the QSFP package are turned off to save power). Each SFP interface has a corresponding “TxDis” pin that is only used to signal the transmitter disabled mode.

In operation, if the translation circuitry 413 receives a low power mode signal from the LpMode/TxDis pin of the QSFP interface 410, the translation circuitry 413 ignores the signal. By contrast, if the host wants to disable all four optical transmitters across the transceivers of all four SFP interfaces, it will send the appropriate signal on the LpMode/TxDis pin. In response, the translation circuitry 413 asserts the transmitter disable signal along the TxDis wire of each SFP interface.

If the host desires to only turn off the transmitter of one, two or three transceivers across the four SFP interfaces 412, the host sends a corresponding signal to the corresponding SFP interface(s) via the SCL/SDA lines. That is, a separate I²C command is individually sent to each transceiver that is to have its transmitter turned off. Each I²C command identifies its specific target transceiver and the translation circuitry 413 enables the TxDis pin of the SFP interface of the targeted transceiver.

The QSFP interface 410 also includes an “IntL/RxLOSL” output pin that is nominally used in QSFP transceiver implementations to transport two signals from any of the four QSFP transceivers in a QSFP package to the host: 1) an interrupt; and, 2) an (optional) optical receiver loss of light signal (if any of the four optical receivers in a QSFP package suffers a problem or its receiver does not detect any light, an appropriate signal is sent on the IntL/RxLOSL pin to the host). Each SFP interface has a corresponding “RxLOSL” pin that is only used to signal a receiver loss of light signal.

In operation, the translation circuitry 413 cannot receive an interrupt signal from any of the SFP interfaces because the SFP interface does not support an interrupt signal. By contrast, in an embodiment, if the optical receiver in each of four transceivers across all four SFP suffers a loss of signal condition (all four SFP transceivers assert a loss of light signal on their respective RxLOSL wire), the translation circuitry 413 asserts a signal on the “IntL/RxLOSL” wire of the QSFP interface 410. If less than all of the transceivers assert a loss of light signal, for each asserting transceiver, an I²C signal is sent over the SCL/SDA wires from the translation circuitry 413 to the host that signifies a loss of light problem and that identifies the asserting transceiver.

The QSFP interface 410 also includes a “ModPresL” (module present) output that is asserted in QSFP transceiver implementations when a QSFP module is inserted into a QSFP connector. Each SFP interface includes a logically opposite pin “Mod_ABS” that is asserted if an SFP transceiver is not connected to the corresponding SFP interface. In an embodiment, if the translation circuitry 413 observes that any SFP interface is not asserting its Mod_ABS wire (meaning that SFP interface has an SFP transceiver coupled to it), the translation circuitry 413 asserts a signal on the ModPresL input pin of the QSFP interface.

The QSFP interface 410 also includes a “ModselL” (module select) wire that is used to enable I²C communications over the SCL/SDA wires of the QSFP interface. Here, it is conceivable that the SCL/SDA wires of the QSFP interface 410 are coupled to multiple QSFP interfaces (the I²C bus that the SCL/SDA wires are components of is used to control more than one QSFP interface). As such, a mechanism is needed to decipher when the signals that are present on the SCL/SDA wires of the QSFP interface are intended for the QSFP interface (or some other QSFP interface). If the ModselL output pin is asserted, the QSFP interface is the target of the present communication on the QSFP interface's SCL/SDA wires. As such, in response, the QSFP interface's SCL/SDA wires are received and processed (are not ignored).

In operation, if the ModselL input is asserted, the translation circuitry 413 understands that the communication that is being received on the SCL/SDA wires of the QSFP interface 410 is intended for one or more of the SFP transceivers that the translation circuitry 413 is coupled to. As such, it receives and forwards the signals to the appropriate transceiver(s) that the host is sending them to using the SCL/SDA wires of the corresponding SFP interface(s).

The QSFP interface 410 also includes a “ResetL” (module reset) input pin. In QSFP transceiver implementations, if the host asserts the ResetL pin through the QSFP interface 410, all four transceivers within a QSFP package will be reset. The SFP interfaces do not have a module reset input. In operation, in an embodiment, the translation circuitry 413 resets itself if the host asserts the ResetL input. As part of the reset, in an embodiment, the translation circuitry acknowledges the reset by toggling the Tx Disable pin.

Each of the SFP interfaces 412 also include two wires that are not included in the QSFP interface: Tx_Fault (transmitter fault) and RS0/RS1 (rate select). For illustrative ease, neither of these wires are depicted in the SFP interfaces 410 of FIG. 4. In nominal SFP transceiver implementations, if an SFP transceiver observes a problem with its optical transmitter, it asserts the Tx_Fault wire of its SFP interface. Also, SFP transceivers generally support two different data rates. In nominal SFP transceiver implementations, the RS0/RS1 wire of an SFP interface is used by the host to inform the SFP transceiver which rate is to be used (e.g., a first rate is to be used if RS0/RS1 is logic high, whereas, a second rate is to be used if RS0/RS1 is logic low).

As such, in an embodiment, if any transceiver asserts the Tx_Fault through its corresponding SFP interface, the translation circuitry 413 informs the host of the problem by sending a communication through the SCL/SDA wires of the QSFP interface 410. The transceiver having the problem is identified as part of the communication. By contrast, if the host desires to configure a particular SFP transceiver with a particular rate, the host sends signals to the translation circuitry 413 over the SCL/SDA wires of the QFSFP interface 410 that identifies which transceiver is being configured and identifies the rate for that SFP transceiver. The translation circuitry 413 processes the signals and sets the RS0/RS1 pin of the SFP interface for the targeted receiver to the desired rate setting.

FIG. 5 depicts an embodiment of the circuitry 513 on the transceiver module that the low level program code (e.g., configuration software and/or firmware) and/or host hardware uses to communicates to the SFP transceivers directly as SFP devices rather than through QSFP to SFP translation as described just above with respect to FIG. 4. As observed in FIG. 5, the QSFP specific wires of the QSFP interface 510 (LP Mode/TxDis, IntL/RxLOSL, etc.) are not used. Instead, the host communicates control signals to the SFP transceivers through the SCL/SDA wires of the QSFP interface 510. The SCL/SDA wires not only transport a particular command but also the identity of the specific SFP transceiver that is to receive the command.

The circuitry 513 includes an I²C switch 513_1 and an I/O expander 513_2. The I²C switch 513_1 directs SCL/SDA signals that are received at the QSFP interface 520 through the specific SFP interface that is coupled to the targeted transceiver. To the extent that commands sent over the SCL/SDA wires of the QSFP interface 520 directly correspond to an SFP specific command, the I/O expander 513_2 converts such commands to a corresponding wire of the SFP interface of the transceiver that is targeted by the command. The Tx_Fault and RS0/RS1 wires associated with the SFP interfaces are not depicted in FIG. 5 for illustrative convenience.

Although embodiments above have stressed separate flex cable fingers that separately run to individual SFP transceivers, in other embodiments a “cage” may be affixed to the transceiver end of the flex cable that includes receptacles for four SFP transceivers. As such, the flex cable need not have a separate finger for each SFP interface. Rather, all four SFP interfaces run together over the cable to the cage. Up to four SFP transceivers can be plugged into the cage.

In various embodiments, referring back to FIG. 2, the electronic circuit board 211 is an adaptor card (e.g., networking adaptor card) that plugs into a host system. Here, the compactness of providing signaling for up to four transceivers through a single QSFP connector 210 allows for an adaptor card that can support multiples of four transceivers per card. For example, if two, three or four QSFP connectors 210 are integrated on the card 211, the card 211 can support up to eight, twelve or sixteen SFP transceivers. This particular feature helps solve the instant problem of integrating as many links as is practicable into the communication infrastructure.

It is pertinent to point that although embodiments described above have stressed the use of SFP transceivers and an adaptor that allows signaling for up to four SFP transceivers through a single QSFP interface, adaptors for other kinds of transceivers or communication links can be used that plug into the QSFP connector 210 of the circuit board 211 (again, the circuit board 211 can be a component of (but is not limited to), e.g., a network adaptor card, a network interface card (NIC) or a system motherboard).

For example, a first type of adaptor has the receptacles and electronics to support copper cabling (instead of fiber optics), various adaptors can have connectors on the transceiver side, and associated wiring, for fiber optic links other than SFP or copper/coaxial cable (e.g., BASE-T transceivers with an RJ-45 connector, Common Public Radio Interface (CFPI), Synchronous Ethernet (SyncE) (which could include a repeater with dock recovery capability, a delay phase locked loop (DPLL), and an enhanced oscillator (TCXO or OCXO) to implement SyncE independent of the network adaptor card or network interface card (NIC)) to which it is attached). Other adaptors support different kinds of transceivers on a single adaptor (e.g., two SFP transceivers and two copper cable links).

Although embodiments above have stressed a QSFP interface that supports the signaling for up to four transceivers through a single QSFP interface, other embodiments can use an interface/connector on the host side of the adaptor other than a QSFP interface/connector. For example, the adaptor can have an OSFP interface/connector on the host side to support up to eight transceivers through a single host side interface.

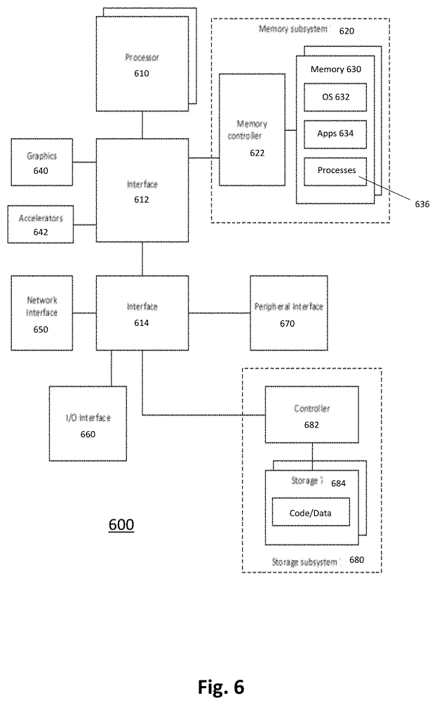

The following discussion concerning FIGS. 6, 7 and 8 are directed to systems, data centers and rack implementations, generally. It is pertinent to point out that any electronic circuit board of any of the systems, data centers and rack implementations described below can include a connector that connects to an adaptor as described at length above to which multiple transceivers can connect.

FIG. 6 depicts an example system. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Certain systems also perform networking functions (e.g., packet header processing functions such as, to name a few, next nodal hop lookup, priority/flow lookup with corresponding queue entry, etc.), as a side function, or, as a point of emphasis (e.g., a networking switch or router). Such systems can include one or more network processors to perform such networking functions (e.g., in a pipelined fashion or otherwise).

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), “X” processing units (XPUs), programmable control logic circuitry, and programmable processing elements such as field programmable gate arrays (FPGAs). Accelerators 642 can provide multiple neural networks, processor cores, or graphics processing units can be made available for use by artificial intelligence (AI) or machine learning (ML) models. For example, the AI model can use or include any or a combination of: a reinforcement learning scheme, O-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, volatile memory, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software functionality to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610. In some examples, a system on chip (SOC or SoC) combines into one SoC package one or more of: processors, graphics, memory, memory controller, and Input/Output (I/O) control logic circuitry.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory), JESD235, originally published by JEDEC in October 2013, LPDDR5, HBM2 (HBM version 2), or others or combinations of memory technologies, and technologies based on derivatives or extensions of such specifications.

In various implementations, memory resources can be “pooled”. For example, the memory resources of memory modules installed on multiple cards, blades, systems, etc. (e.g., that are inserted into one or more racks) are made available as additional main memory capacity to CPUs and/or servers that need and/or request it. In such implementations, the primary purpose of the cards/blades/systems is to provide such additional main memory capacity. The cards/blades/systems are reachable to the CPUs/servers that use the memory resources through some kind of network infrastructure such as CXL, CAPI, etc.

Additionally, network interface card (NICs) can be pooled, server blades can be pooled. Any of these (memory resources, NICs, server blades) can include a circuit board having an interface for receiving an adaptor as described at length above.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a HyperTransport or industry standard architecture (ISA) bus, a small computer system interface (SCSI) bus, Remote Direct Memory Access (RDMA), Internet Small Computer Systems Interface (iSCSI), NVM express (NVMe), Coherent Accelerator Interface (CXL), Coherent Accelerator Processor Interface (CAPI), Cache Coherent Interconnect for Accelerators (CCIX), Open Coherent Accelerator Processor (Open CAPI) or other specification developed by the Gen-z consortium, a universal serial bus (USB), or an Institute of Electrical and Electronics Engineers (IEEE) standard 1394 bus.

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a remote device, which can include sending data stored in memory. Network interface 650 can receive data from a remote device, which can include storing received data into memory. Various embodiments can be used in connection with network interface 650, processor 610, and memory subsystem 620.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits in both processor 610 and interface 614.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented as a disaggregated computing system. For example, the system 600 can be implemented with interconnected compute sleds of processors, memories, storages, network interfaces, and other components. High speed interconnects can be used such as PCIe, Ethernet, or optical interconnects (or a combination thereof). For example, the sleds can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Although a computer is largely described by the above discussion of FIG. 6, other types of systems to which the above described invention can be applied and are also partially or wholly described by FIG. 6 are communication systems such as routers, switches and base stations.

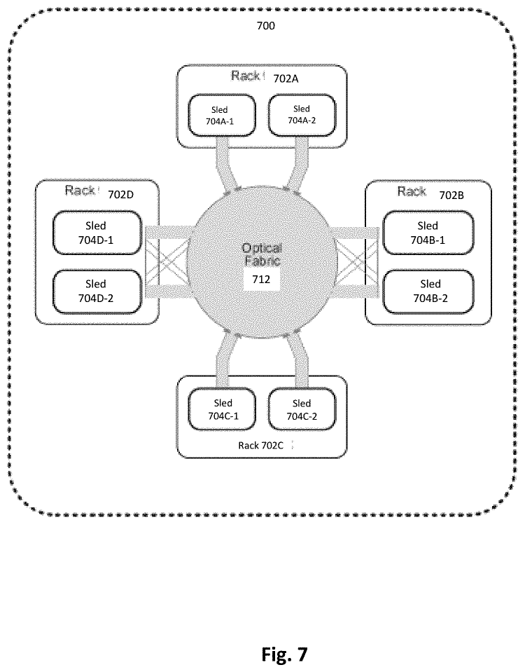

FIG. 7 depicts an example of a data center. Various embodiments can be used in or with the data center of FIG. 7. As shown in FIG. 7, data center 700 may include an optical fabric 712. Optical fabric 712 may generally include a combination of optical signaling media (such as optical cabling) and optical switching infrastructure via which any particular sled in data center 700 can send signals to (and receive signals from) the other sleds in data center 700. However, optical, wireless, and/or electrical signals can be transmitted using fabric 712. The signaling connectivity that optical fabric 712 provides to any given sled may include connectivity both to other sleds in a same rack and sleds in other racks.

Data center 700 includes four racks 702A to 702D and racks 702A to 702D house respective pairs of sleds 704A-1 and 704A-2, 704B-1 and 704B-2, 704C-1 and 704C-2, and 704D-1 and 704D-2. Thus, in this example, data center 700 includes a total of eight sleds. Optical fabric 712 can provide sled signaling connectivity with one or more of the seven other sleds. For example, via optical fabric 712, sled 704A-1 in rack 702A may possess signaling connectivity with sled 704A-2 in rack 702A, as well as the six other sleds 704B-1, 704B-2, 704C-1, 704C-2, 704D-1, and 704D-2 that are distributed among the other racks 702B, 702C, and 702D of data center 700. The embodiments are not limited to this example. For example, fabric 712 can provide optical and/or electrical signaling.

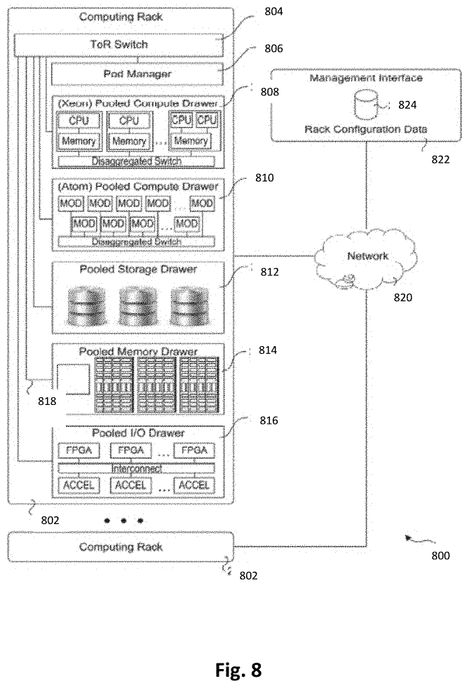

FIG. 8 depicts an environment 800 that includes multiple computing racks 802, each including a Top of Rack (ToR) switch 804, a pod manager 806, and a plurality of pooled system drawers. Generally, the pooled system drawers may include pooled compute drawers and pooled storage drawers to, e.g., effect a disaggregated computing system. Optionally, the pooled system drawers may also include pooled memory drawers and pooled Input/Output (I/O) drawers. In the illustrated embodiment the pooled system drawers include an INTEL® XEON® pooled computer drawer 808, and INTEL® ATOM™ pooled compute drawer 810, a pooled storage drawer 812, a pooled memory drawer 814, and a pooled I/O drawer 816. Each of the pooled system drawers is connected to ToR switch 804 via a high-speed link 818, such as a 40 Gigabit/second (Gb/s) or 100 Gb/s Ethernet link or an 100+Gb/s Silicon Photonics (SiPh) optical link. In one embodiment high-speed link 818 comprises an 600 Gb/s SiPh optical link.

Again, the drawers can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Multiple of the computing racks 800 may be interconnected via their ToR switches 804 (e.g., to a pod-level switch or data center switch), as illustrated by connections to a network 820. In some embodiments, groups of computing racks 802 are managed as separate pods via pod manager(s) 806. In one embodiment, a single pod manager is used to manage all of the racks in the pod. Alternatively, distributed pod managers may be used for pod management operations. RSD environment 800 further includes a management interface 822 that is used to manage various aspects of the RSD environment. This includes managing rack configuration, with corresponding parameters stored as rack configuration data 824.

Any of the systems, data centers or racks discussed above, apart from being integrated in a typical data center, can also be implemented in other environments such as within a bay station, or other micro-data center, e.g., at the edge of a network.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be implemented using or as an article of manufacture or at least one computer-readable medium. A computer-readable medium may include a non-transitory storage medium to store program code. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the program code implements various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

To the extent any of the teachings above can be embodied in a semiconductor chip, a description of a circuit design of the semiconductor chip for eventual targeting toward a semiconductor manufacturing process can take the form of various formats such as a (e.g., VHDL or Verilog) register transfer level (RTL) circuit description, a gate level circuit description, a transistor level circuit description or mask description or various combinations thereof. Such circuit descriptions, sometimes referred to as “IP Cores”, are commonly embodied on one or more computer readable storage media (such as one or more CD-ROMs or other type of storage technology) and provided to and/or otherwise processed by and/or for a circuit design synthesis tool and/or mask generation tool. Such circuit descriptions may also be embedded with program code to be processed by a computer that implements the circuit design synthesis tool and/or mask generation tool.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences may also be performed according to alternative embodiments. Furthermore, additional sequences may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

1. An adaptor, comprising:
a) a first interface, the first interface designed to support traffic and command flows to multiple transceivers through a single instance of the first interface;
b) multiple interfaces on a transceiver side, the multiple interfaces to mate to respective transceivers, the multiple interfaces being different than the first interface, wherein the first interface is a QSFP interface and the multiple interfaces are SFP interfaces;
c) a flex cable between the first interface and the multiple interfaces, and,
d) electronic circuitry to translate QSFP commands received at the first interface into SFP commands presented to the respective transceivers through the multiple interfaces.

2. The adaptor of claim 1 wherein the adaptor further comprises electronic circuitry to express commands received at an I²C channel of the first interface into SFP commands presented to the respective transceivers through the multiple interfaces, wherein, wires that are features of the first interface to send commands are not used.

3. The adaptor of claim 1 wherein the flex cable splits into different fingers having a respective one of the multiple interfaces.

4. The adaptor of claim 1 wherein the multiple transceivers is more than four transceivers.

5. The adaptor of claim 1 wherein the first interface is part of a module that is to plug into a connector on a circuit board that conforms to the first interface.

6. An apparatus, comprising:
a circuit board comprising a connector to connect to a first interface of an adaptor, the first interface being of a first type and being designed to support traffic and command flows to multiple transceivers through a single instance of the first interface, the circuit board to send traffic and commands to respective transceivers that are coupled to the adaptor, the respective transceivers having a different interface than the first interface, wherein the first interface is QSFP and respective interfaces of the respective transceivers are SFP interfaces, and wherein the circuit board is to transmit commands to the respective transceivers through the connector and the adaptor is to translate the commands into corresponding versions supported by the different interface.

7. The apparatus of claim 6 wherein the circuit board is to transmit commands to the respective transceivers through an I²C channel of the first interface, wherein, wires that are features of the first interface to send commands are not used.

8. The apparatus of claim 6 wherein the multiple transceivers is more than four transceivers.

9. A data center, comprising:
a plurality of electronic systems respectively plugged into a plurality of racks, the electronic systems communicatively coupled through one or more communication networks, wherein, an electronic system of the plurality of electronic systems comprises a network adaptor to send information into the one or more networks and to receive information from the one or more networks, wherein the adaptor comprises a), b), c) and d) below:
a) a first interface, the first interface designed to support traffic and command flows to multiple transceivers through a single instance of the first interface;
b) multiple interfaces on a transceiver side, the multiple interfaces to mate to respective transceivers, the multiple interfaces being different than the first interface, wherein the first interface is a QSFP interface and the multiple interfaces are SFP interfaces;
c) a flex cable between the first interface and the multiple interfaces, and,
d) electronic circuitry to translate QSFP commands received at the first interface into SFP commands presented to the respective transceivers through the multiple interfaces

10. The data center of claim 9 wherein the adaptor further comprises electronic circuitry to express commands received at an I²C channel of the first interface into SFP commands presented to the respective transceivers through the multiple interfaces, wherein, wires that are features of the first interface to send commands are not used.

11. The data center of claim 9 wherein the flex cable splits into different fingers having a respective one of the multiple interfaces.

12. The data center of claim 9 wherein the multiple transceivers is more than four transceivers.

13. The data center of claim 9 wherein the multiple interfaces are mechanically integrated into a same cage.

14. The data center of claim 9 wherein the electronic system is a computer system.

15. The data center of claim 9 wherein the electronic system is a networking system.
